(19) United States
(12) Patent Application Publication
(10) Pub. No.: US 2006/0136185 A1
(43) Pub. Date: Jun. 22, 2006

(54) System modeling apparatus and method and controller designing system and method using the same

(76) Inventors: Tae-young Kim, Suwon-si (KR); Sung-ryul Lee, Seoul (KR)

Correspondence Address: STANZIONE & KIM, LLP, 919 18TH STREET, N.W., SUITE 440, WASHINGTON, DC, 20006, US

(21) Appl. No.: 11/300,343

(22) Filed: Dec. 15, 2005

(30) Foreign Application Priority Data
Dec. 16, 2004 (KR) 2004-106841

(51) Int. Cl. G06G 7/48; G06G 7/58

(52) U.S. Cl. 703/11

(57) ABSTRACT

A system modeling apparatus and method and a controller designing system and method of performing a system modeling using the same includes applying a step input of a magnitude to a system of interest, sampling a number of outputs according to a predetermined sampling cycle in response to the step input to the system, applying a least square to the sampled output and the sampling cycle to calculate a presumptive maximum output value and a presumptive time constant of the system, repeating the applying, sampling, and calculating operations by at least two times, by varying the magnitude of the step input, to calculate two or more presumptive maximum output values and presumptive time constants, and calculating a DC gain and a time constant of the system using the calculated presumptive maximum output values and the presumptive time constants.

### CROSS-REFERENCE TO RELATED APPLICATIONS

This application claims the benefit of Korean Patent Application No. 2004-106841 filed on Dec. 16, 2004 in the Korean Intellectual Property Office, the disclosure of which is incorporated herein by reference.

### BACKGROUND OF THE INVENTION

1. Field of the Invention

The present general inventive concept relates to a system modeling apparatus and method, and a controller designing system and method using the same. More particularly, the present general inventive concept relates to a system modeling apparatus and method of controlling a system, in which a steady-state can not be measured during operation of an open-loop, and a controller designing system and method using the same.

2. Description of the Related Art

A proportion integral derivative (PID) controller has been widely used in various types of industrial equipment and controllers. The PID controller has a simple structure and an improved controllability, and can relatively easily adjust a control gain of the equipment and controllers in an industrial area. A proportion control, an integral control, and a derivative control may be used independently or with a combination thereof.

A generic transfer function C(s) for the PID controller is as below:

$$C ( s ) = {K}_{p} + {K}_{d} S + \frac{{K}_{i}}{S} \qquad [ Equation 1 ]$$

where kₚ, k_{d}, kᵢ are a proportional coefficient, a derivative coefficient, and an integral coefficient, respectively. Designing the PID controller means calculating kₚ, k_{d}, kᵢ, which are coefficients of the PID controller. The coefficients of the PID controller can be calculated using a frequency domain designing method, a root-locus method, a transient response method, and a pole placement method. A system should be firstly modeled to design the PID controller.

Hereinafter, a method of obtaining a step response of the system to model the system, assuming that the system is a first system from which the step response is obtained, will be explained.

FIG. 1 is a view illustrating an output of a system supplied by a step input reaching a steady-state in response to a step input. A longitudinal axis y represents a magnitude of the output of the system, the lateral axis t represents a time, yₘₐₓ represents a value of the steady-state, T represents a time when the output reaches 0.632 yₘₐₓ, and u represents a magnitude of the step input.

Generally, an output of a velocity of a direct current (DC) servo system can be approximated to that of the first system. If the system is the DC servo system, a transfer function C(s) can be shown as the below equation.

$$C ( s ) = \frac{Y ( s )}{U ( s )} = \frac{K}{Ts + 1} \qquad [ Equation 2 ]$$

where Y(s) is an output, U(s) is an input, K is a DC gain of the DC servo system, and T is a time constant of the system. The DC gain K of the DC servo system can be obtained by yₘₐₓ/u, the time constant T of the system can be obtained by the time when the output reaches 0.632yₘₐₓ. The modeling of the DC servo system is completed by this process, and the PID controller can be designed using the obtained DC gain and time constant of the system.

FIG. 2 is a view illustrating an output of a system which is not able to reach a steady-state in response to a step input. Here, the output of the system refers to an output from a system receiving the step input. A longitudinal axis is a velocity of a carriage to move an object in the system, and a lateral axis is a time.

As shown in FIG. 2, it is impossible to calculate a value of the steady-state of the output since the system obtains only limited data which does not reach the steady-state. That is, in certain systems, an operation of the systems is completed before the output thereof reaches the steady-state due to a mechanical limitation in driving an open-loop, and an example of such systems includes a printer carriage system which moves to left and right a carriage with a head cartridge jetting an ink via a nozzle according to a print signal so as to perform printing. Accordingly, the DC gain and the time constant of the system can not be obtained so that the system modeling method according to a step response can not be applied.

### SUMMARY OF THE INVENTION

The present general inventive concept provides a system modeling apparatus and method, and a controller designing system and method using the same so that a system which completes an operation before an output of the system reaches a steady-state due to a structural limitation in driving an open-loop, can be efficiently modeled.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a system modeling method of controlling a system-modeling, the system modeling method comprising applying one or more step inputs of different magnitudes to a system, sampling one or more outputs according to a certain sampling cycle in response to corresponding ones of the step inputs to the system, applying a least square to the sampled outputs and the sampling cycle to calculate presumptive maximum output values and presumptive time constants of the system, , and calculating a DC gain and a time constant of the system according to the calculated presumptive maximum output values and the presumptive time constants.

The sampling of the one or more outputs may comprise sampling the one or more outputs only in a section where the one or more outputs increase.

The DC gain may be a gradient of a linear function obtained by approximating to a curve corresponding to the applied step inputs and the calculated presumptive maximum outputs.

The time constant is an average value of the calculated presumptive time constants.

The foregoing and/or other aspects of the present general inventive concept may also be achieved by providing a controller designing method of system-modeling to be used in a controller, the controller designing method comprising applying one or more step inputs of different magnitudes to a system of interest, sampling one or more outputs according to a certain sampling cycle in response to corresponding ones of the step inputs to the system, applying a least square to the sampled one or more output signals and the sampling cycle to calculate presumptive maximum output values and presumptive time constants of the system, calculating a DC gain and a time constant of the system according to the calculated presumptive maximum output values and the presumptive time constants, and applying a pole placement method to the calculated DC gain and time constant to calculate a proportional coefficient and an integral coefficient of the controller.

The proportional coefficient and the integral coefficient are calculated by the following equation:

$${K}_{p} = \frac{2 ζ ϖ T - 1}{{K}_{1}} , {T}_{i} = \frac{2 ζ ϖ T - 1}{{ϖ}^{2} T}$$

where Kₚ is a proportional coefficient of the controller, Tᵢ is the integral coefficient of the controller, T is the calculated time constant of the system, K₁ is a DC gain of the system, and ‘ζ’ is a preset attenuation ratio and ‘\overline{ω}’ is a preset natural frequency.

The foregoing and/or other aspects of the present general inventive concept may also be achieved by providing a system modeling apparatus to control system-modeling, a system modeling apparatus comprising a signal input part to apply one or more step input of different magnitudes to a system of interest, a presumptive value calculation part to sample one or more outputs according to a certain sampling cycle in response to corresponding ones of the step inputs to the system, and to apply a least square to the sampled outputs and the sampling cycle to calculate two or more presumptive maximum output values and the presumptive time constants, respectively, and a system coefficient calculation part to calculate a DC gain and a time constant of the system according to the calculated presumptive maximum output values and the presumptive time constants.

The foregoing and/or other aspects of the present general inventive concept may also be achieved by providing a controller designing system to system-modeling to be used in a controller, the controller designing system comprising a signal input part to apply one or more step inputs of different magnitudes to a system, a presumptive value calculation part to sample one or more outputs according to a certain sampling cycle in response to corresponding ones of the step inputs to the system, and to apply a least square to the sampled outputs and the sampling cycle to calculate two or more presumptive maximum output values and presumptive time constants, respectively, a system coefficient calculation part to calculate a DC gain and a time constant of the system according to the calculated presumptive maximum output values and presumptive time constants, and a controller designing part to apply a pole placement to the calculated DC gain and time constant to calculate a proportional coefficient and an integral coefficient of the controller.

The foregoing and/or other aspects of the present general inventive concept may also be achieved by providing an image forming apparatus comprising a controller having a proportional coefficient and an integral coefficient to control the image forming apparatus, wherein the proportional coefficient and the integral coefficient are calculated by a controller designing method comprising applying one or more step inputs of different magnitudes to a system, sampling one or more outputs according to a predetermined sampling cycle in response to corresponding ones of the step inputs to the system, calculating presumptive maximum output values and presumptive time constants of the system according to the sampled one or more outputs and the sampling cycle, calculating a DC gain and a time constant of the system according to the calculated presumptive maximum output values and the presumptive time constants, and applying a pole placement method to the calculated DC gain and time constant to calculate the proportional coefficient and the integral coefficient

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an output of a system which reaches a steady-state in response to a step input in a conventional system;

FIG. 2 is a view illustrating an output of a system which does not reach a steady-state in response to a step input in a conventional system;

FIG. 3 is a block diagram illustrating a controller designing system and a system of interest according to an embodiment of the present general inventive concept;

FIG. 4 is a detailed block diagram illustrating a system modeling part of the controller designing system of FIG. 3;

FIG. 5 is a view illustrating an approximating process using a curve fitting a presumptive maximum output and a step input to a linear function; and

FIG. 6 is a flowchart illustrating a controller designing method according to an embodiment of the present general inventive concept.

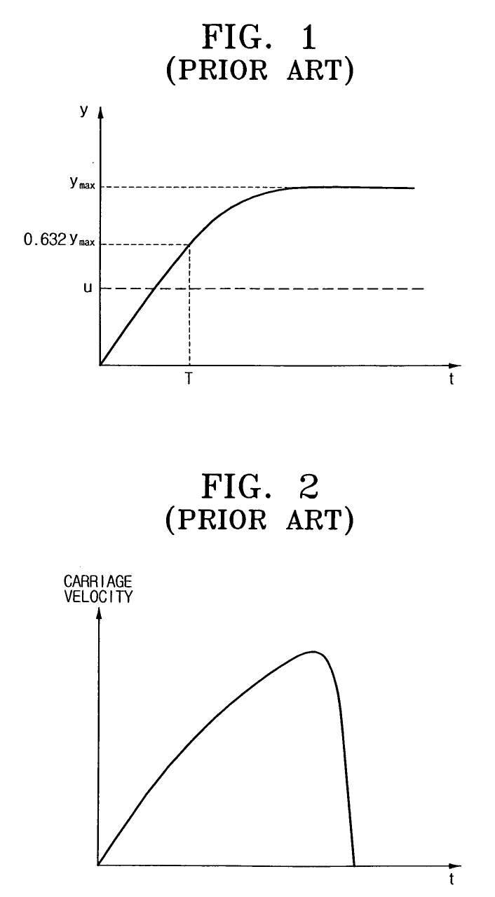

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A system of interest that is used in embodiments of the present general inventive concept will be explained as follows.

The system of interest may be a direct current (DC) servo system in which an operation of the DC servo system is completed before an output thereof reaches a steady-state due to a mechanical limitation in driving an open-loop such that a conventional system modeling method according to a step response can not be applied. An example of the system of interest may include a printer carriage system usable with an image forming apparatus and having a motor to move a print head so as to print an image on a sheet of paper. When a controller that is used to control the motor of the printer carriage system or the DC servo system is designed, one of printer carriage systems or DC servo systems is used as the system of interest for system modeling. Thus, the controller of the printer carriage system can be designed using a system modeling result of the system of interest.

Here, an output of a velocity of the DC servo system may approximate to a first system (system of interest) using the following equation 3.

$$Y ( s ) = \frac{{K}_{1}}{{T}_{s} + 1} U ( s ) - \frac{{K}_{2}}{{T}_{s} + 1} D ( s )$$

where Y(s) is an output velocity, U(s) is an input voltage, D(s) is a disturbance, K₁, K₂ are DC gains, and T is a time constant. The disturbance D(s) is assumed to regularly occur.

A velocity output function in a time domain as Equation 4 may be obtained by applying the inverse Laplace transformation to equation 3.

$$y ( t ) = ( {K}_{1} u ( t ) - {K}_{2} d ) ( 1 - {ⅇ}^{- \frac{t}{T}} ) \qquad [ Equation 4 ]$$

where d is a disturbance of a regular magnitude.

Equation 4 is transformed to equation 5 so as to apply the least square to the velocity output function.

$$y ( t ) = {Y}_{max} ( 1 - {ⅇ}^{- \frac{t}{T}} ) \qquad [ Equation 5 ]$$

Then, equation 6 is obtained by integrating both sides of equation 5 with respect to from 0 to t_{f}. Yₘₐₓ is a maximum output of the system including an influence of the disturbance to a step input u(t) of a certain magnitude, and T is a time constant of the system.

$$\begin{matrix}{\int }_{0}^{{t}_{f}} y ( t ) ⅆ t = {\int }_{0}^{{t}_{f}} {Y}_{max} ( 1 - {ⅇ}^{- \frac{t}{T}} ) ⅆ t \\ = {Y}_{max} {t}_{f} - Ty ( {t}_{f} )\end{matrix} \qquad [ Equation 6 ]$$

The left side of equation 6 may be recursively calculated using the trapezoidal rule as shown in the following equation 7.

$${\int }_{k Δ t}^{( k + 1 ) Δ t} y ( t ) ⅆ t \approx \frac{Δ t}{2} ( y ( ( k + 1 ) Δ t ) + y ( k Δ t ) ) \qquad [ Equation 7 ]$$

where Δt is a sampling cycle, and y(kΔt) is a k-th sampled output.

The equation 7 may be rephrased as placed as Y(k)=X(k) Φ to define Y(k), X(k), and Φ.

$$Y ( k ) = {\sum }_{n = 0}^{n = k} \frac{Δ t}{2} ( y ( ( n + 1 ) Δ t ) + y ( n Δ t ) ) \\ X ( k ) = [ k Δ t - y ( k Δ t ) ] \\ Φ = {[ {Y}_{max} T ]}^{t} \qquad [ Equation 8 ]$$

where Y(k) and X(k) are measurable variables, and Φ is a parameter to be presumed.

If the step input of a certain magnitude is applied to the system, an output ‘y(kΔt)’ is calculated per a certain sampling cycle ‘Δt’, and the least square is applied to the output, and thus, Φ can be obtained. For example, if the number of the sampled output is M, Φ can be obtained according to the least square as shown in the following process.

The parameter Φ can be obtained by equation 9 since Φ=(X^{T}X)⁻¹X^{T}Y, and X=[X(1)X(2). . . X(M)]^{T}, Y=[Y(1)Y(2). . . Y(M)]^{T}.

$$\begin{matrix}[ \begin{matrix}{Y}_{max} \\ T\end{matrix} ] = {( [ \begin{matrix}Δ t & ⋯ & M Δ t \\ - y ( Δ t ) & ⋯ & - y ( M Δ t )\end{matrix} ] [ \begin{matrix}Δ t & - y ( Δ t ) \\ ⋮ & ⋮ \\ M Δ t & - y ( M Δ t )\end{matrix} ] )}^{- 1} \\ ( [ \begin{matrix}Δ t & ⋯ & M Δ t \\ - y ( Δ t ) & ⋯ & - y ( M Δ t )\end{matrix} ] \\ [ \begin{matrix}{\sum }_{n = 0}^{n = 1} \frac{Δ t}{2} ( y ( n + 1 ) Δ t + y ( n Δ t ) ) \\ ⋮ \\ {\sum }_{n = 0}^{n = M} \frac{Δ t}{2} ( y ( n + 1 ) Δ t + y ( n Δ t )\end{matrix} ]\end{matrix} \qquad [ Equation 9 ]$$

In other words, if the step input of a certain size is applied to the first system and the least square is applied to data corresponding to the output Y(kΔt), a presumptive maximum output value Yₘₐₓ and a presumptive time constant T can be obtained. Here, the data is obtained by sampling the output value per a certain sampling cycle.

FIG. 3 is a block diagram illustrating a controller designing system 100 and a system (system of interest) 200 according to an embodiment of the present general inventive concept.

Referring to FIG. 3, the controller designing system 100 according to an embodiment of the present general inventive concept comprises a system modeling part 110 and a controller designing part 120. The system modeling part 110 supplies a step input u(n) to the system 200 and samples an output y(t) of the system 200 in response to the input u(n) so that a DC gain K₁ and a time constant T can be obtained according to a certain method. The controller designing part 120 obtains a proportional coefficient Kₚ and an integral coefficient Tᵢ of a controller of a DC servo system, such as a printer carriage system, corresponding to the system 200, using the DC gain K₁, and the time constant T calculated from the system modeling part 110 to design the controller. The system modeling part 110 and the controller designing part 120 will be explained in detail hereinafter.

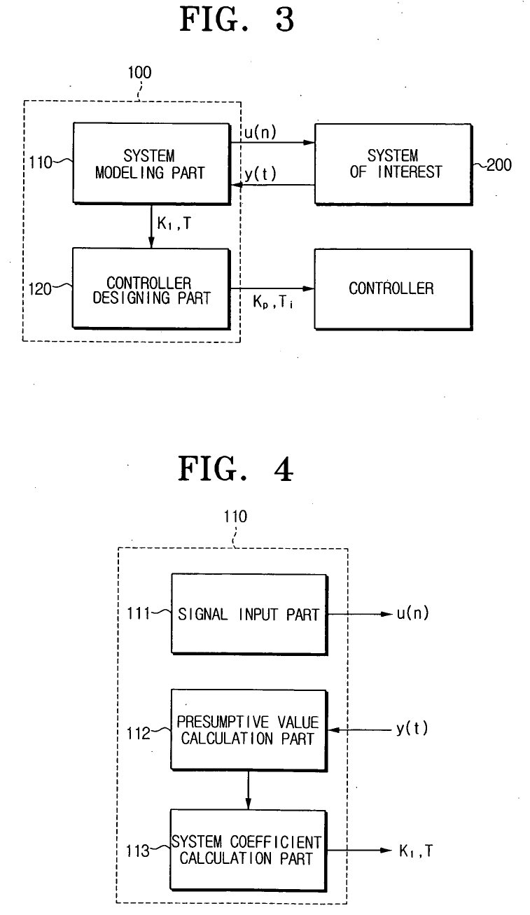

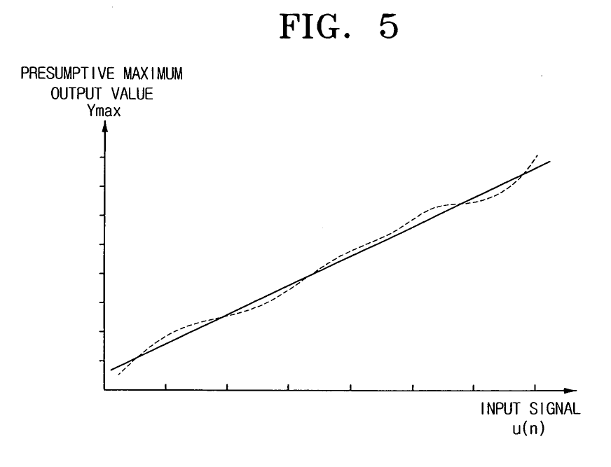

FIG. 4 is a detailed block diagram illustrating the system modeling part 110 of the system modeling part 110 of FIG. 3.

Referring to FIGS. 3 and 4, the system modeling part 110 according to the present embodiment comprises a signal input part 111, a presumptive value calculation part 112, and a system coefficient calculation part 113.

The signal input part 111 applies the step input u(n) of a certain magnitude to the system 200 so that the presumptive value calculation part 112 can sample the output (y(t)) of the system 200. The step input u(n) can be expressed by u₀+(n−1)Δu where u₀ is an initial magnitude of the step input u(n). For example, the signal input part 111 applies the step input u(1) of the initial magnitude u₀ to the system 200, and reapplies a new step input u(2) of u₀+Δu magnitude to the system 200 as the presumptive value calculation part 112 completes sampling the output y(t) in response to the input u(1) such that the output y(t) in response to the input u(2) can be sampled in the presumptive value calculation part 112. The signal input part 111 repeats the above process N times with n increasing from 1 to N. The N is a preset value, and the number N of repetitions of the above-described process may be increased to improve a reliability of system modeling.

The presumptive value calculation part 112 samples a certain number of the output ‘y(kΔt)’ from the system 200 per a preset sampling cycle ‘Δt’ in a unit section with an increasing output and applies the least square according to the above equation 9 to the sampled output such that a presumptive maximum output Yₘₐₓ and a presumptive time constant T can be calculated. If the signal input part 111 inputs the input from u(1) to u(N) N times, the presumptive value calculation part 112 calculates N number of the presumptive maximum outputs Yₘₐₓ (1) to Yₘₐₓ (N) and N number of the presumptive time constants T(1) to T(N) so as to provide the system coefficient calculation part 113.

The sampling in the unit section is limited to a section in which the output increases because the above-described operation is performed in the system of interest 200 before the output reaches a steady-state due to a structural limitation thereof. An output in the unit section which decreases is a signal which is output after the operation of the system is already stopped. Accordingly, the signal in the unit section in which the output decreases is improper for modeling the system 200. Additionally, the sampling cycle ‘Δt’ may be shortened and the presumptive value calculation part 112 may be implemented to calculate the presumptive maximum output Yₘₐₓ and the presumptive time constant T as much as possible so that the system 200 can be more accurately modeled.

The system coefficient calculation part 113 calculates the DC gain and the time constant T of the system 200 using the N number of the presumptive maximum output values Yₘₐₓ and the N number of the presumptive time constants T calculated from the presumptive value calculation part 112. The system coefficient calculation part 113 approximates via a curve fitting a relationship between the applied step inputs u(1), u(2), . . . , u(N) and the calculated presumptive maximum outputs Yₘₐₓ (1), Yₘₐₓ (2), . . . , Yₘₐₓ (N) to obtain a gradient of a linear function. The system coefficient calculation part 113 sets the gradient to be the DC gain Kᵢ, of the system 200. This process will be explained in detail with reference to FIG. 5. FIG. 5 is a view illustrating an approximating process using a curve corresponding to a linear function of the presumptive maximum output values and the step inputs. A dotted line shows the presumptive maximum output values Yₘₐₓ calculated in response to the step input u(n) to the system 200, and a solid line represents the linear function approximating to curve corresponding to the presumptive maximum output values Yₘₐₓ, which may be expressed as Yₘₐₓ=K₁u(n)+K₂d. Here, K₁=(Yₘₐₓ−K₂d)/u(n), and therefore, K₁, will be the DC gain of the system 20 in view of an influence of disturbance on the system 200.

The system coefficient calculation part 113 sets an average value of the calculated presumptive time constants to be the time constant of the system 200. By this process, the DC gain K₁ and the time constant T of the system 200 are obtained and the system modeling is completed.

Referring back to FIG. 3, the controller designing part 120 applies a pole placement method according to Equation 10 to the DC gain K₁ and the time constant T of the system 200 calculated from the system modeling part 110 so as to obtain the proportional coefficient Kₚ and the integral coefficient Tᵢ of a controller of the DC servo system or the print carriage system 300.

$${K}_{p} = \frac{2 ζ ϖ T - 1}{{K}_{1}} , {T}_{i} \frac{2 ζ ϖ T - 1}{{ϖ}^{2} T} \qquad [ Equation 10 ]$$

where Kₚ is the proportional coefficient of the controller, Tᵢ is the integral coefficient of the controller, T is the calculated time constant of the system, and K₁ is the calculated DC gain of the system. ‘ζ’ is an attenuation ratio and ‘\overline{ω}’ is a natural frequency. The attenuation ratio ‘ζ’ and the natural frequency ‘\overline{ω}’ are preset by a designer of the controller according to a desired output type from the system 200.

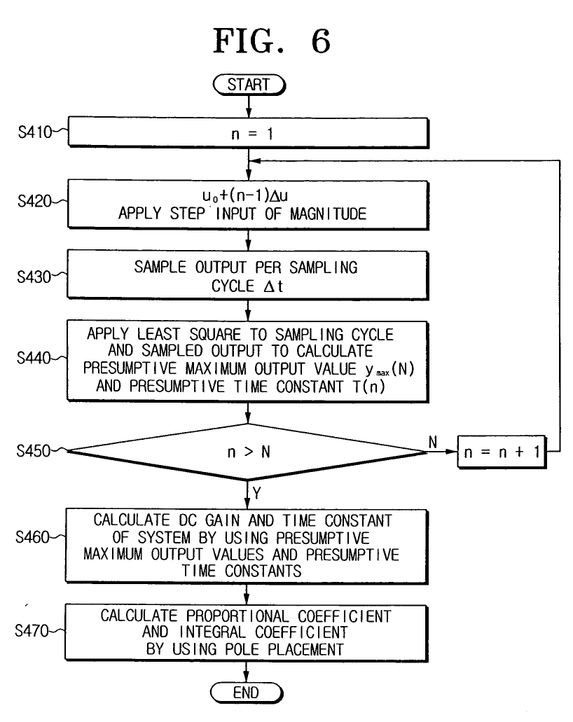

FIG. 6 is a flowchart illustrating a method of designing a controller of a DC servo system according to an embodiment of the present general inventive concept.

Referring to FIGS. 3, 4, and 6, the signal input part 111 sets 1 as the coefficient ‘n’ indicating the n-th input to the system 200 (S410), and applies the step input u(n) of u₀+(n−1)Δu magnitude to the system 200 (S420).

The presumptive value calculation part 112 samples the output y(t) of the system 200 in response to the input u(n) per preset sampling cycle ‘Δt’ (S430), and applies the sampled output to the least square according to aforementioned Equation 9 such that the presumptive maximum output value Yₘₐₓ (n) and the presumptive time constant T(n) can be calculated (S440).

The signal input part 111 and the presumptive value calculation part 112 repeats the operations of S420, S430, S440 until the coefficient ‘n’ is greater than the preset certain value N (S450). Here, N is a preset value, and the number N of repetitions of the above-described operations may be increased to improve a reliability of the system modeling.

The system coefficient calculation part 113 calculates the DC gain Kᵢ and the time constant T of the system 200 according to the N number of the presumptive maximum output values Yₘₐₓ (n) and the N number of the presumptive time constants T(n) calculated from the presumptive value calculation part 112 (S460). The DC gain of the system 200 is set to be the gradient of the linear function, and the time constant is set to be an average value of the presumptive time constants. The gradient of the linear function is obtained by approximating to a curve corresponding to the relationship between magnitudes u(1), u(2), . . . , u(N) of the applied step input, and the calculated presumptive maximum output values Yₘₐₓ (1), Yₘₐₓ (2), . . . , Yₘₐₓ (N). As described above according to present embodiment, the DC gain K₁ and the time constant T of the system 200 can be obtained to be used in designing the controller, and the system modeling can be completed.

Finally, the controller designing part 130 applies the pole placement to the DC gain K₁ and the time constant T of the system 200 with the completed system modeling such that the proportional coefficient Kₚ and the integral coefficient Tᵢ can be calculated and the controller (300) can be automatically synchronized (S470).

As described above, in the embodiments of the present general inventive concept, the system modeling method according to the step response is applied to the system of interest so that the modeling can be easily performed even when the system stops the operation before the output thereof reaches the steady-state due to the structural limitation in driving the open-loop.

The DC gain of the system 200 can be calculated in view of the influence of disturbance on the system 200.

The controller can be easily designed and can control the modeled system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system modeling method of controlling a system-modeling, the system modeling method comprising:
applying one or more step inputs of different magnitudes to a system;
sampling one or more outputs according to a predetermined sampling cycle in response to corresponding ones of the step inputs to the system;
calculating presumptive maximum output values and presumptive time constants of the system according to the sampled one or more outputs; and
calculating a DC gain and a time constant of the system according to the calculated presumptive maximum output values and the presumptive time constants.

2. The method as claimed in claim 1, wherein the sampling of the outputs comprises sapling the outputs in a unit section where the outputs increase.

3. The method as claimed in claim 1, wherein the DC gain is a gradient of a linear function obtained by approximating to a curve corresponding to the applied step inputs and the calculated presumptive maximum outputs.

4. The method as claimed in claim 1, wherein the time constant is an average value of the calculated presumptive time constants.

5. The method as claimed in claim 1, wherein the calculating of the presumptive maximum output values and presumptive time constants comprises:
applying a least square to the sampled one or more outputs and the sampling cycle to calculate the presumptive maximum output values and presumptive time constants.

6. The method as claimed in claim 1, wherein the calculating of the presumptive maximum output values and presumptive time constants comprises:
terminating the calculating of the presumptive maximum output values and presumptive time constants when the sampled one or more outputs decrease.

7. The method as claimed in claim 1, wherein:
the one or more step inputs comprise first and second step inputs having first and second magnitudes, respectively;
the one or more outputs comprise first and second outputs corresponding to the first and second step inputs; and
the sampling of the one or more outputs comprises sampling the first and second outputs when the second output is greater than the first output.

8. The method as claimed in claim 7, wherein the sampling of the first and second output comprises terminating the sampling the first and second outputs when the second output is less than the first output.

9. The method as claimed in claim 1, wherein:
the one or more step inputs comprise first, second, and third step inputs, respectively;
the one or more outputs comprise first, second, and third outputs corresponding to the first, second, and third step inputs; and
the sampling of the one or more outputs comprises sampling the first and second outputs when the third output is less than one or the first and second outputs.

10. The method as claimed in claim 9, wherein the sampling of the one or more outputs comprises terminating the sampling the third output when the third output is less than the second output.

11. The method as claimed in claim 9, wherein the third output represents a non-steady state.

12. The method as claimed in claim 1, wherein the one or more outputs are divided by a unit section corresponding to the sampling cycle, and the unit section of one of the one or more outputs does not represent a non-steady state but an increasing state.

13. The method as claimed in claim 1, wherein the one or more step input can be expressed by u₀+(n−1)Δu where u₀ is an initial magnitude of the step input u(n) and n is a natural number.

14. A controller designing method of system-modeling, the controller designing method comprising:
applying one or more step inputs of magnitudes to a system;
sampling one or more outputs according to a predetermined sampling cycle in response to corresponding ones of the step inputs to the system;
calculating presumptive maximum output values and presumptive time constants of the system according to the sampled one or more output signals and the sampling cycle;
calculating a DC gain and a time constant of the system according to the calculated presumptive maximum output values and the presumptive time constants; and
applying a pole placement method to the calculated DC gain and time constant to calculate a proportional coefficient and an integral coefficient of a controller.

15. The method as claimed in claim 14, wherein the proportional coefficient and the integral coefficient are calculated by the following equation:
$${K}_{p} = \frac{2 ζ ϖ T - 1}{{K}_{1}} , {T}_{i} = \frac{2 ζ ϖ T - 1}{{ϖ}^{2} T}$$
where Kₚ is the proportional coefficient of the controller, Tᵢ is the integral coefficient of the controller, T is the calculated time constant of the system, K₁ is the DC gain of the system, ‘ζ’ is a preset attenuation ratio, and ‘\overline{ω}’ is a preset natural frequency.

16. The method as claimed in claim 14, wherein the calculating of the presumptive maximum output values and presumptive time constants comprises:
applying a least square to the sampled one or more outputs and the sampling cycle.

17. The method as claimed in claim 14, wherein:
the one or more step inputs comprise first, second, and third step inputs, respectively;
the one or more outputs comprise first, second, and third outputs corresponding to the first, second, and third step inputs; and
the sampling of the one or more outputs comprises sampling the first and second outputs when the third output is less than one or the first and second outputs.

18. The method as claimed in claim 17, wherein the sampling of the one or more outputs comprises terminating the sampling the third output when the third output is less than the second output.

19. The method as claimed in claim 17, wherein the third output represents a non-steady state.

20. The method as claimed in claim 14, wherein the one or more step inputs can be expressed by u₀+(n−1)Δu where u₀ is an initial magnitude of the step input u(n) and n is a natural number.

21. The method as claimed in claim 14, wherein the controller comprises a printer carriage system of an image forming apparatus to move a printer head to print an image on a sheet of paper.

22. A system modeling apparatus to control a system-modeling, comprising:
a signal input part to apply one or more step inputs having different magnitudes to a system;
a presumptive value calculation part to sample one or more outputs according to a predetermined sampling cycle in response to corresponding ones of the step inputs to the system, and to apply a least square to the sampled one or more outputs and the sampling cycle to calculate two or more presumptive maximum output values and the presumptive time constants, respectively; and
a system coefficient calculation part to calculate a DC gain and a time constant of the system according to the calculated presumptive maximum output values and the presumptive time constants.

23. The apparatus as claimed in claim 22, wherein the presumptive value calculation part samples the outputs in a unit section where the outputs increase.

24. The apparatus as claimed in claim 22, wherein the DC gain of the system is a gradient of a linear function obtained by approximating to a curve corresponding to the applied step inputs and the calculated presumptive maximum values.

25. The apparatus as claimed in claim 22, wherein the time constant is an average value of the calculated presumptive time constants.

26. A controller designing system to perform a system modeling, comprising:
a signal input part to apply one or more step inputs of different magnitudes to a system;
a presumptive value calculation part to sample one or more outputs according to a predetermined sampling cycle in response to corresponding to the respective step inputs to the system, and to apply a least square to the sampled outputs and the sampling cycle to calculate two or more presumptive maximum output values and presumptive time constants, respectively;
a system coefficient calculation part to calculate a DC gain and a time constant of the system according to the calculated presumptive maximum output values and presumptive time constants; and
a controller designing part to apply a pole placement to the calculated DC gain and time constant to calculate a proportional coefficient and an integral coefficient of a controller.

27. The system as claimed in claim 26, wherein the proportional coefficient and the integral coefficient are obtained by the following equation:
$${K}_{p} = \frac{2 ζ ϖ T - 1}{{K}_{1}} , {T}_{i} = \frac{2 ζ ϖ T - 1}{{ϖ}^{2} T}$$
where Kₚ is the proportional coefficient of the controller, Tᵢ is the integral coefficient of the controller, T is the calculated time constant of the system, K₁ is the DC gain of the system, ‘ζ’ is a preset attenuation ratio, and ‘\overline{ω}’ is a preset natural frequency.

28. An image forming apparatus comprising:
a controller having a proportional coefficient and an integral coefficient to control the image forming apparatus,
wherein the proportional coefficient and the integral coefficient are calculated by a controller designing method comprising applying one or more step inputs of magnitudes to a system, sampling one or more outputs according to a predetermined sampling cycle in response to corresponding ones of the step inputs to the system, calculating presumptive maximum output values and presumptive time constants of the system according to the sampled one or more outputs and the sampling cycle, calculating a DC gain and a time constant of the system according to the calculated presumptive maximum output values and the presumptive time constants, and applying a pole placement method to the calculated DC gain and time constant to calculate the proportional coefficient and the integral coefficient.
